(19) United States
(12) Patent Application Publication
(10) Pub. No.: US 2007/0169764 A1
(43) Pub. Date: Jul. 26, 2007

(54) Air swirling device

(76) Inventor: Kuang-Hsiung Lo, Su-Lin (TW)

Correspondence Address: Kuang-Hsiung Lo, P.O. Box 55-846, Taipei, 104, TW

(21) Appl. No.: 11/368,837

(22) Filed: Mar. 7, 2006

(30) Foreign Application Priority Data
Jan. 24, 2006 (TW) 95201539

(51) Int. Cl. F02M 29/00; F02M 29/02

(52) U.S. Cl. 123/592; 123/590

(57) ABSTRACT

An air swirling device comprises a pipe member connected in between an air cleaner and an internal combustion engine; a plurality of swirl-flow ducts spirally formed in the pipe member; and a central-flow duct axially formed in the pipe member and surrounded by the swirl-flow ducts; with each swirl-flow duct being formed by a swirl plate spirally secured to an inside wall of the pipe member and juxtapositionally partially linked to each adjacent swirl plate; whereby upon suction by the engine, the inlet air will be guided and swirled by the plural swirl-flow ducts to form swirling air flow, as accompanied with a central air flow through the central-flow duct, for homogeneously mixing fuel with air for enhancing a complete combustion of fuel to thereby increase the engine performance. The air whirling device may also be modified to be installed between the engine and an exhaust or tail pipe.

### BACKGROUND OF THE INVENTION

U.S. Pat. No. 5,113,838 disclosed an air flow system for an internal combustion engine comprising a swirling device having a plurality of vanes for causing air to swirl for improving the properties of the air-fuel mixture and improving the engine performance.

Each vane includes at least a slit cut in the vane for causing the air to swirl. However, such a prior art has the following drawbacks:
1. Each vane has been cut out with at least a slit therethrough to thereby cause great pressure drop when the air flow passing through the slit in the vane, thereby reducing the air flow rate entering the internal combustion engine and being still unsatisfactory for helping the complete combustion of fuel in the engine.
2. After being used for a time period, the slits in the vanes may be accumulated with dirts or pollutants thereon or even be clogged to dampen or influence the air streamflow to reduce the air supply for entrance in the engine.
3. The slit as cut in the vane may cause whistling and noise pollution.
4. The vanes having been cut with slits therein may weaken their strength to possibly shorten the service life of the device.

The present inventor has found the drawbacks of the conventional air flow system and invented the present air swirling device.

### SUMMARY OF THE INVENTION

The object of the present invention is to provide an air swirling device comprising a pipe member connected in between an air cleaner and an internal combustion engine; a plurality of swirl-flow ducts spirally formed in the pipe member; and a central-flow duct axially formed in the pipe member and surrounded by the swirl-flow ducts; with each swirl-flow duct being formed by a swirl plate spirally secured to an inside wall of the pipe member and juxtapositionally partially linked to each adjacent swirl plate; whereby upon suction by the engine, the inlet air will be guided and swirled by the plural swirl-flow ducts to form swirling air flow, as accompanied with a central air flow through the central-flow duct, for homogeneously mixing fuel with air for enhancing a complete combustion of fuel to thereby increase the engine performance.

### BRIEF DESCRIPTION OF THE DRAWINGS

FIG. 1 is an illustration of the air swirling device of the present invention.

FIG. 2 is a front view of the air swirling device of the present invention.

FIG. 3 is an exploded view showing the elements of the present invention.

FIG. 4 is an illustration showing the assembly of the present invention in an air flow system.

FIG. 5 shows another preferred embodiment of the present invention.

### DETAILED DESCRIPTION

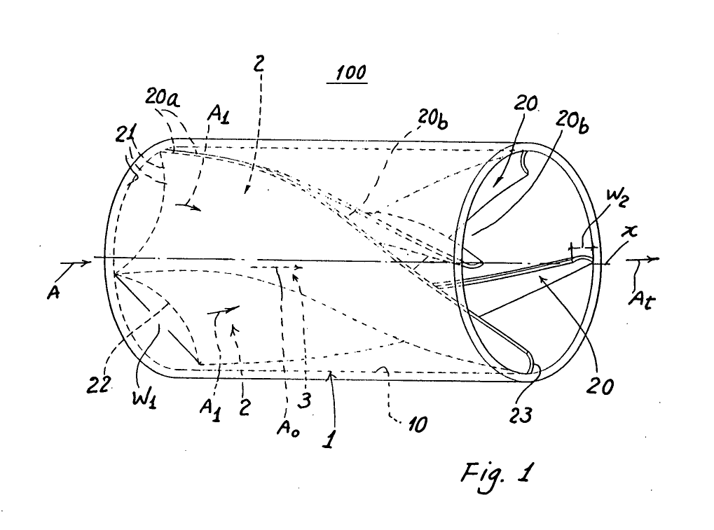

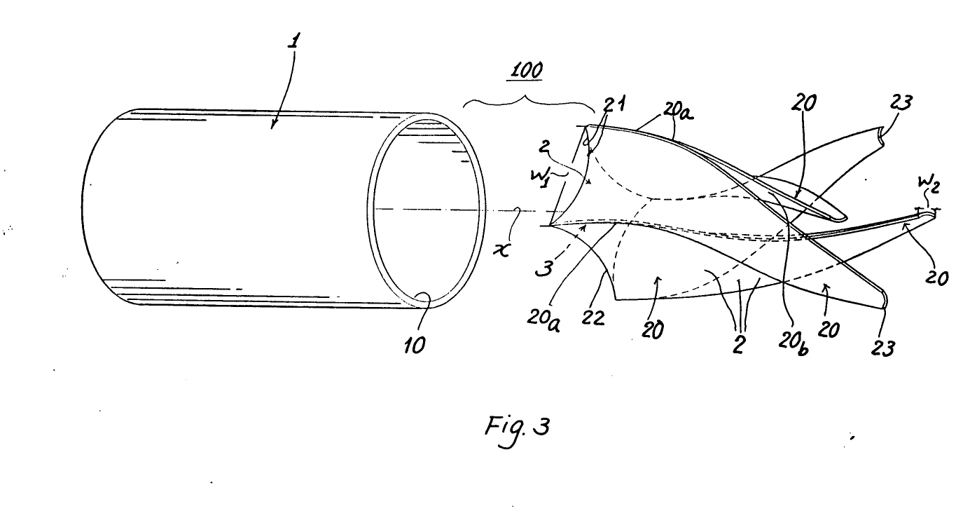

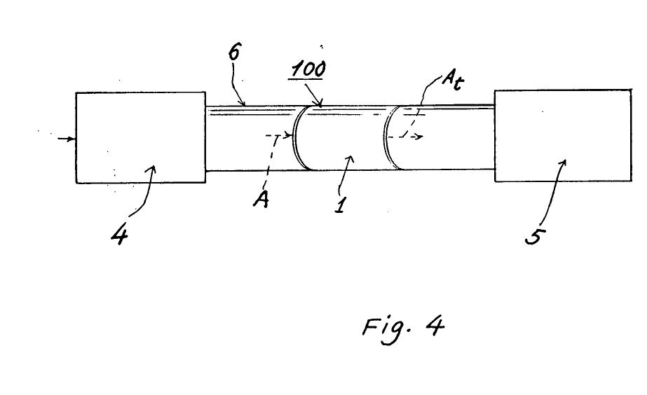

As shown in FIGS. 1-4, the present invention comprises an air swirling device 100 inserted or connected in an air inlet pipe or hose 6 as connected in between an air cleaner 4 and an internal combustion engine 5 of a car or the like as shown in FIG. 4.

The air swirling device 100 of the present invention comprises: a pipe member 1 connected in between an air cleaner 4 and an engine 5 (as shown in FIG. 4) or inserted in an air inlet pipe 6 between the air cleaner 4 and the engine 5; a plurality of swirl-flow ducts 2 spirally formed in the pipe member 1 about an axis X defined at a longitudinal center of the pipe member 1; and a central-flow duct 3 axially formed in the pipe member 1 and surrounded by the plurality of swirl-flow ducts 2; whereby upon suction by the engine, the inlet air flow A will be swirled as guided by the plurality of swirl-flow ducts 2 to form a plurality of streams of swirling air flow A₁ to be combined with a central air flow A₀ through the central-flow duct 3 to enter the engine.

Each swirl-flow duct 2 includes: a swirl plate 20 spirally secured to an inside cylindrical wall 10 of the pipe member 1 and has a linking portion 20a of the swirl plate 20 integrally connected with a neighboring or adjacent swirl plate 20 to define a cross section of meniscus shape 21 between the swirl plate 20 and the inside wall 10 of the pipe member 1.

The number of swirl-flow ducts 2 are not limited in this invention and there are four swirl-flow ducts 2 as shown in the drawings as accompanied with this application.

Each swirl plate 20 has a first edge 22 defining a first width W₁, and a second edge 23 gradually decreasing its width from the first edge 22 to have a second width W₂ smaller than the first width W₁ to reduce the friction loss and pressure drop of the air flow passing through the swirl plate 20.

Each swirl-flow duct 2 has a bifurcated opening 20b defined between every two neighboring swirl plates 20 and located adjacent to the second edge 23 of each swirl plate 20 to fluidically communicate the swirling air flow A₁ as guided by the swirl-flow duct 2 with the central air flow A₀ as guided by the central-flow duct 3 to form a forced-draft swirling air flow At entering the internal combustion engine of a car or the like.

The present invention has the following advantages superior to the prior art:
1. The inlet air (from the air cleaner) will be guided into plural streams of swirling air flow A₁ by the plural swirl-flow ducts 2 and a central air flow A₀ as guided by the central-flow duct 3 to form the forced-draft swirling air flow At to homogeneously mix the fuel and the air for enhancing a complete combustion for increasing the engine horse power, torque, and engine performance.
2. Each swirl-flow duct 2 is formed by each swirl plate 20 as spirally formed in the pipe member 1 to form a strong swirling or twisting air flow into the engine with enough air flow rate, speed and pressure to rapidly accelerate the fuel combustion even at a first moment for starting or accelerating the engine to thereby help facilitate to reach the desired driving speed of a car.
3. The forced-draft swirling air flow, when meeting a surge of high pressure or back pressure caused in the inlet air streamflow before entering the engine, may be automatically “harmonized” by the central air flow through the central-flow duct 3 which successfully serves as a “buffer” fluid so as to prevent from temporary interruption of inlet air flow as fed into the engine to thereby maintain a smooth engine operation.
4. The swirl plates 20 are partially linked together to form the central-flow duct 3 and circumferentially secured with the inside cylindrical wall 10 of the pipe member 1 to form the swirl-flow ducts 2 to firmly secure the ducts 2, 3 with one another and secure the ducts with the pipe member 1 to be durable for vibrational shock for prolong the service life thereof.
5. Each plate 20 is not cut with any slit therethrough to thereby cause no damage to reduce the strength of the plate 20, also being not whistled for preventing from noise pollution.
6. The carbon accumulated in the catalyst converter and muffler in a tail pipe may be well flushed, purged and removed by a smooth exhaust gas as discharged from the engine when installed with the air swirling device of the present invention so as to reduce the engine load, and to save fuel consumption.
7. Thanks to the forced-draft air streamflow through the air swirling device of the present invention, the air as passing through the air cleaner will be further enhanced to accelerate the air filtration effect in the air cleaner and also to facilitate the air streamflow through the air cleaner, thereby synergetically enhancing the operation efficiency of the complete air supply system of an engine.

The air swirling device of the present invention may also be installed in between the engine and a tail or exhaust pipe including a catalyst converter and a muffler; or at any other locations.

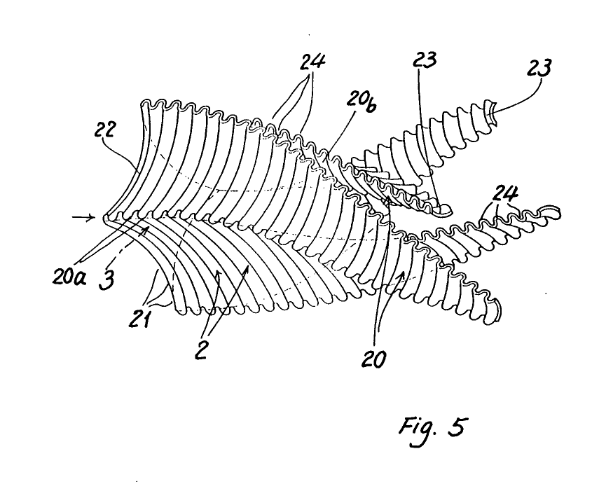

As shown in FIG. 5, each swirl plate 20 is formed with corrugations 24 comprised of ridges and grooves alternatively and repeatedly formed on each swirl plate 20 so as to produce small eddy (not shown) of the air streamflow when flowing through the swirl plate 20. Such small eddy will further help a more homogeneous mixing of air and fuel in the internal combustion engine for a thoroughly complete combustion in the engine.

Briefly, the large swirling flow caused by the ducts 2 plus the small eddy flow caused by the corrugations 24 on each swirl plate 20 will synergetically enhance an absolutely complete combustion of the air-fuel mixture to thereby enhance the engine performance.

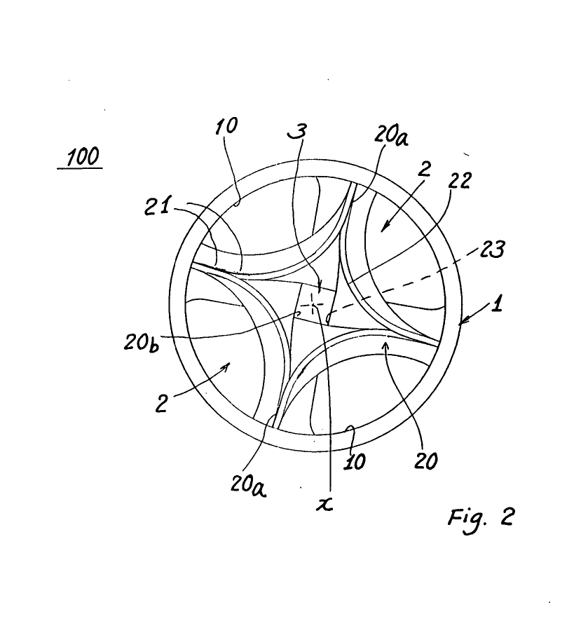

The central-flow duct 3, especially as shown in FIG. 2, has a cross section of polyhedral or polygonal shape including lozenge shape; and each swirl-flow duct 2 has a cross section of meniscus or elliptical shape.

Of course, the shapes of the ducts 2, 3 are not limited in the present invention. The orientation of the present invention may also be inverted to be installed in between the engine and the air cleaner.

The present invention may be further modified without departing from the spirit and scope of the present invention.

I claim:

1. An air swirling device comprising: a pipe member connected in between an air cleaner and an internal combustion engine; a plurality of swirl-flow ducts spirally formed in the pipe member about an axis defined at a longitudinal center of the pipe member; and a central-flow duct axially formed in the pipe member and surrounded by the plurality of swirl-flow ducts; whereby upon suction by the engine, the inlet air flow will be swirled as guided by the plurality of swirl-flow ducts to form a plurality of streams of swirling air flow to be combined with a central air flow through the central-flow duct to form a forced-draft air flow to enter the engine;
each said swirl-flow duct including: a swirl plate spirally secured to an inside cylindrical wall of the pipe member and having a linking portion of the swirl plate connected with a neighboring swirl plate to define a cross section of meniscus shape or elliptical shape between the swirl plate and the inside wall of the pipe member; and
said central-flow duct confined by said plurality of said swirl plates linked with one another and having a cross section of polyhedral or polygonal shape.

2. An air swirling device according to claim 1, wherein each said swirl plate includes a first edge defining a first width, and a second edge gradually decreasing its width from the first edge to have a second width smaller than the first width to reduce a friction loss or pressure drop of air flow passing through the swirl plate.

3. An air swirling device according to claim 1, wherein each said swirl-flow duct includes a bifurcated opening defined between every two neighboring swirl plates and located adjacent to a second edge of each said swirl plate to fluidically communicate the swirling air flow as guided by the swirl-flow duct with the central air flow as guided by the central-flow duct to form said forced-draft air flow entering the engine.

4. An air swirling device according to claim 1, wherein each said swirl plate is formed with corrugations comprised of ridges and grooves alternatively and repeatedly formed on each said swirl plate so as to produce small eddy of an air streamflow when flowing through the swirl plate.

5. An air swirling device comprising: a pipe member connected to an internal combustion engine and a tail pipe; a plurality of swirl-flow ducts spirally formed in the pipe member about an axis defined at a longitudinal center of the pipe member; and a central-flow duct axially formed in the pipe member and surrounded by the plurality of swirl-flow ducts;
each said swirl-flow duct including: a swirl plate spirally secured to an inside cylindrical wall of the pipe member and having a linking portion of the swirl plate connected with a neighboring swirl plate to define a cross section of meniscus shape or elliptical shape between the swirl plate and the inside wall of the pipe member; and
said central-flow duct confined by said plurality of said swirl plates linked with one another and having a cross section of polyhedral or polygonal shape.
